(19) United States
(12) Patent Application Publication
(10) Pub. No.: US 2006/0042957 A1
(43) Pub. Date: Mar. 2, 2006

(54) Ion removal from particulate material using electrodeionization process and devices therefor

(76) Inventor: Chunzhi He, Woodstock, GA (US)

Correspondence Address: NEEDLE & ROSENBERG, P.C., SUITE 1000, 999 PEACHTREE STREET, ATLANTA, GA, 30309-3915, US

(21) Appl. No.: 10/928,302

(22) Filed: Aug. 27, 2004

(51) Int. Cl. B01D 61/42; C02F 1/461

(52) U.S. Cl. 205/687; 204/627

(57) ABSTRACT

Methods are disclosed for the electrodeionization and removal of at least some of at least one type of ion from an ion-containing particulate material comprising passing a direct current for a sufficient time between (a) an anode and (b) a cathode, wherein the anode and the cathode are both in electrical contact with an aqueous slurry of the particulate material, wherein the anode is in electrical contact with an anion exchange membrane and wherein the cathode is in electrical contact with a cation exchange membrane, thereby causing the removal of at least some of the at least one type of ion to be removed from the particulate material. Also disclosed are devices for the electrodeionization and removal of at least some of at least one type of ion from an ion-containing particulate material.

### FIELD OF THE INVENTION

This invention relates to the removal of ions from a particulate material using electrodeionization processes. In one aspect, the particulate material is a catalyst for fuel cell applications.

### BACKGROUND

The activity of particulates, such as catalysts, can be significantly affected by impurities. This is especially true for electrocatalysts used in proton exchange membrane (PEM) fuel cells. Electrocatalysts, especially platinum-based electrocatalysts, can strongly adsorb chloride ions. As a result, these catalysts can lose active sites resulting in decreased activity. Therefore, anions, such as chloride ions, should be removed from fuel cell catalysts to a very low level.

Cations affect fuel cell catalyst performance through a different mechanism. Cations can exchange with protons in proton exchange membranes, such as, for example, Nafion® membranes. Cations also replace protons of ionomers in the catalyst layers. When protons in the membrane and ionomers are exchanged by other cations, fuel cell resistance increases and its performance decreases.

Therefore, anions and/or cations should be removed from fuel cell catalysts to a very low level. Prior art methods of reducing ion content include high temperature sequential water washes or Soxhlet extraction. However, it is very difficult to reduce ions to a very low level simply by washing, because most catalyst supports are high surface area materials, which inherently have strong adsorption for many ion species. Traditional water washing-filtration processes are also very slow and consume large amounts of water.

Ion contaminants can affect other particulate material in addition to electrocatalysts. For example, ions can contribute to corrosion in various systems, and ion contaminants can interfere with matrix chemistries. Examples of other systems that can be affected by ion impurities include, but are not limited to, wire and cable systems, top coat coatings, ink and coating systems, and other electronic applications.

Electrodeionization (EDI) has been used in water purification for the removal of solvated ionic species. See, for example, U.S. Pat. No. 5,425,858, issued Jun. 20, 1995, to Farmer.

U.S. Pat. No. 6,254,752 B1, issued Jul. 3, 2001, to Miller, discloses an EDI process for the removal of chloride ions from a finished product of reinforced concrete. The cathode is located internally in the concrete itself.

European Published Patent Application 0 241 308 A1, published Oct. 14, 1987, to Vaccare, discloses a method for removing or displacing selected ions from a filter cake formed of solids of suspension by an electronically augmented vacuum filter by an EDI process. However, the ion concentration, especially the chloride ion concentration, was not reduced to a level acceptable for many applications, such as for an electrocatalyst purification.

Therefore, there exists a need in the art for processes and devices for producing a particulate material having a low level of anions and/or cations.

### SUMMARY

In one aspect, the invention relates to a method for the electrodeionization and removal of at least some of at least one type of ion from an ion-containing particulate carbonaceous material comprising passing a direct current for a sufficient time between (a) an anode and (b) a cathode,
wherein the anode and the cathode are both in electrical contact with an aqueous slurry of the particulate carbonaceous material,
wherein the anode is in electrical contact with an anion exchange membrane and
wherein the cathode is in electrical contact with a cation exchange membrane,
thereby causing the removal of at least some of the at least one type of ion to be removed from the carbonaceous material.

In yet another aspect, the invention relates to a method for the electrodeionization and removal of at least some of at least one type of ion from an ion-containing particulate material comprising passing a direct current for a sufficient time between (a) an anode and (b) a cathode,
wherein the anode and the cathode are both in electrical contact with an aqueous slurry of the particulate material,
wherein the anode is in electrical contact with an anion exchange membrane and
wherein the cathode is in electrical contact with a cation exchange membrane,
thereby causing the removal of at least some of the at least one type of ion to be removed from the material.

In yet another aspect, the invention relates to a device for the electrodeionization and removal of at least some of at least one type of ion from an ion-containing particulate material comprising:
a power source; and
a cell comprising:
(a) a first chamber defining a first interior cavity;
(b) a second chamber defining a second interior cavity;
(c) an anode contained at least partially in the first interior cavity, the anode electrically coupled to the power source;
(d) a cathode contained at least partially in the second interior cavity, the cathode electrically coupled to the power source;
(e) an anion exchange membrane positioned adjacent a bottom end of the first chamber, the anion exchange membrane having a base surface;
(e) a cation exchange membrane positioned adjacent a bottom end of the second chamber, the cation exchange membrane having a base surface; and
(f) an anion and cation exchange resin mixture layer positioned adjacent to the respective base surfaces of the anion and cation exchange membranes,
wherein the respective anion and cation exchange membranes are disposed between the anode and the cathode, respectively, and the resin mixture layer.

In yet another aspect, the invention relates to a frame member for a cell for the electrodeionization and removal of at least some of at least one type of ion from an ion-containing particulate material, comprising:
an anion exchange membrane;
a cation exchange membrane; and
a member having an upper surface and an opposed lower surface, the member defining a first opening and a second opening extending between the upper and lower surfaces and forming a common wall member extending between a portion of the first opening and a portion of the second opening, wherein the anion exchange membrane is mounted in the first opening of the member, and
wherein the cation exchange membrane is mounted in the second opening of the member.

In yet another aspect, the invention relates to a frame member for a cell for the electrodeionization and removal of at least some of at least one type of ion from an ion-containing particulate material, comprising:
an anion and cation exchange resin mixture layer;
a filter membrane; and
a substantially planar member having a top face and an opposed bottom face, the member defining at least one opening extending between the top face and the bottom face, wherein the anion and cation exchange resin mixture layer is mounted within an upper portion of the at least one opening proximate the top face of the member, and wherein the filter membrane is mounted within a lower portion of the at least one opening proximate the bottom face of the member.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 is a schematic view of a batch device of the invention.

FIG. 2 is a perspective view of a first embodiment of a batch device of the invention.

FIG. 3 is a top view of the batch device of FIG. 2.

FIG. 4 is a cross-sectional view of the batch device of FIG. 3 taken across line 4-4.

FIG. 5 is side elevational view of a cell body of the batch device of FIG. 2.

FIG. 6 is a bottom view of the cell body of FIG. 5.

FIG. 7 is a side elevational view of an upper frame member of the batch device of FIG. 2.

FIG. 8 is a top view of the upper frame member of FIG. 7.

FIG. 9 is side elevational view of a lower frame member of the batch device of FIG. 2.

FIG. 10 is a top view of the lower frame member of FIG. 9.

FIG. 11 is a top view of a sleeve of the batch device of FIG. 2.

FIG. 12 is a side elevational view of the sleeve of FIG. 11.

FIG. 13 is a perspective view of a second embodiment of a batch device of the invention.

FIG. 14 is a partial cross-sectional view of the batch device of FIG. 13 showing the upper frame member and lower frame member disposed therein.

FIG. 15 is a continuous device that can be used in one aspect of the processes of the present invention.

### DETAILED DESCRIPTION

Before the present compounds, compositions, articles, devices, and/or methods are disclosed and described, it is to be understood that the aspects described below are not limited to specific synthetic methods, or specific materials as such may, of course, vary. It is also to be understood that the terminology used herein is for the purpose of describing particular aspects only and is not intended to be limiting.

Disclosed are materials, compounds, compositions, and components that can be used for, can be used in conjunction with, can be used in preparation of, or are products of the disclosed method and compositions. These and other materials are disclosed herein, and it is understood that when combinations, subsets, interactions, groups, etc. of these materials or processes are disclosed that while specific reference of each various individual and collective combinations and permutations of these compounds or processes may not be explicitly disclosed, each is specifically contemplated and described herein. For example, if a catalyst substrate is disclosed and discussed and a number of metal catalysts for use on the catalyst substrate are discussed, each and every combination and permutation of the catalyst substrate are specifically contemplated unless specifically indicated to the contrary. Thus, if a class of substrates A, B, and C are disclosed as well as a class of metals D, E, and F and an example of a combination, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions, devices for making the disclosed compositions, and the compositions themselves. Thus, if there are a variety of additional steps that can be performed, it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

It must be noted that, as used in the specification and the appended claims, the singular forms “a,” “an” and “the” include plural referents unless the context clearly dictates otherwise. Thus, for example, reference to “a metal” includes mixtures of metals, reference to “a particle” includes mixtures of two or more particles, and the like.

“Optional” or “optionally” means that the subsequently described event or circumstance can or cannot occur, and that the description includes instances where the event or circumstance occurs and instances where it does not. For example, the phrase “optionally heated” means that the process may or may not be heated and that the description includes both unheated and heated embodiments.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

“Carbonaceous” refers to a solid material comprised substantially of elemental carbon. “Carbonaceous material” is intended to include, without limitation, i) carbonaceous compounds having a single definable structure; or ii) aggregates of carbonaceous particles, wherein the aggregate does not necessarily have a unitary, repeating, and/or definable structure or degree of aggregation.

“Carbon black” is a conductive acinoform carbon utilized, for example, as a catalyst support.

“Electrical contact” as used herein refers to either a hard wire or a non-hard wire arrangement to cause a current to flow through the system. For example, the anode is typically hard wired to the power source, which is typically hard wired to the cathode. However, the anode and the cathode are typically not hard wired to the aqueous slurry of the particulate material. The ions present in the aqueous slurry of the particulate material create, in this portion of the system, a pathway for the current to flow through the system rather than through a hard wire.

“Electrolyte” refers to the ion exchange resin, the aqueous portion of the slurry, or the resin and aqueous portion together.

“Electrodeionization” refers to an electrochemical process where a voltage is applied across an anode and a cathode and the electrical potential causes the removal of an ion from a particular substrate.

“Metal” as used herein in reference to the metal loaded on a substrate, (e.g. a carbonaceous or non-carbonaceous substrate) can be, e.g., one or more of a precious metal, a noble metal, a platinum group metal, platinum, an alloy or oxide of any of the above, or a composition that includes a transition metal or oxide of any of the above. As used herein, it is a “metal” that acts as a catalyst for the reactions occurring in the fuel cell or other catalytic operation. The metal may be tolerant of CO containing contaminants and may also be used in direct methanol fuel cells.

“Particulate” means a material of separate solid particles.

In accordance with this invention, it has been found that, among other things, an electrodeionization process can remove ions from an aqueous slurry of particulates. In one specific aspect, the ion containing particulates are carbonaceous particulate materials. In a more particular aspect, an EDI process is used for the purification of a particulate carbonaceous material of a carbon supported catalyst.

In one aspect, such an EDI process provides improved efficiency of purification, specifically, a greater reduction in ionic species for a given amount of time and/or energy expenditure and/or material expenditure. In another aspect, such an EDI process can achieve a lower absolute value of the ionic species on the particulate material. In yet another aspect, the EDI process of the invention provides a reduced operating temperature for purifying a particulate material. Prior art methods typically utilize a 70°-80° C. sequential water washing or a 100° C. Soxhlet extraction versus a typical temperature of 45° C. for the process of the instant invention. This reduced temperature of the invention minimizes potential sintering of material especially for metal loaded catalysts, such as metal loaded carbon supported catalysts. The process of the invention also produces superior results in comparison to the removal of ions from a filter cake. Not wishing to be bound by theory, it is believed that the contaminant ions migrate more efficiently from a slurry rather than from a filter cake.

Although this process is effective for ion removal from an electrocatalyst, it can also be used for removing ions from other type catalysts as well as non-catalyst solids. Thus, this invention is not limited to electrocatalysts, but applies to all particulate material. Any non-ionic solid containing soluble ionic impurities can be used in this invention. Examples of non-carbonaceous ion containing particulate materials include, but are not limited to, silica, alumina, zeolites, titania (titanium dioxide), carbides, non-carbonaceous catalyst materials (for example, precious metals supported on silica, alumina, or zeolites), and organic solids containing ionic impurities (for example, olefin polymer beads containing soluble ionic impurities). Examples of non-catalytic, carbonaceous material include, but are not limited to, carbon black, graphite, nanocarbons, fullerenes, fullernic material, finely divided carbon, or mixtures thereof. Examples of other non-electrocatalytic applications include wire and cable applications, top coat coatings, ink and coating systems, and other electronic applications.

For carbonaceous catalyst material, the carbonaceous material can be any particulate, substantially carbonaceous material. For example, carbon black, graphite, nanocarbons, fullerenes, fullerenic material, finely divided carbon, or mixtures thereof can be used. The carbonaceous substrate can be substituted, such as with sulfonated groups. Such sulfonated substituted carbon black is shown in WO 2003/100889, which publication is herein incorporated by reference in its entirety and for its teachings of sulfonated substituted carbon black.

The carbonaceous catalyst material can be carbon black. The choice of carbon black in the invention is not critical. Any carbon black can be used in the invention. Carbon blacks with surface areas (nitrogen surface area, NSA, ASTM D6556) of about 200 to about 1400 m²/g, for example, about 200, 220, 240, 250, 300, 350, 400, 450, 500, 550, 600, 650, 700, 750, 800, 850, 950, 1000, 1100, 1200, 1300, or 1400 m²/g can be used. In one aspect, a carbon black with a surface area of 240 m²/g (NSA, ASTM D6556) can be used. It is preferred that the carbon black have a surface area effective for metal dispersion. It is preferred that the carbon black have structure effective for gas diffusion.

Those skilled in the art will appreciate that carbon black particles have physical and electrical conductivity properties which are primarily determined by the particle and aggregate size, aggregate shape, degree of graphitic order, and surface chemistry of the particle.

Also, the conductivity of highly crystalline or highly graphitic particles is higher than the conductivity of more amorphous particles. Generally, any of the forms of carbon black particles is suitable in the practice of the present invention and the particular choice of size, structure, and degree of graphitic order depends upon the physical and conductivity requirements desired for the carbon black.

One of skill in the art could readily choose an appropriate carbon black for a particular application. Various carbon blacks are commercially available (e.g., Columbian Chemical Company, Atlanta, Ga.).

The particulate carbonaceous catalyst material can be a material other than carbon black. The choice of other carbonaceous material in the invention is not critical. Any substantially carbonaceous material can be used in the invention. For example, graphite, nanocarbons, fullerenes, fullerenic material, finely divided carbon, or mixtures thereof can be used.

It is preferred that the carbonaceous catalyst material have a surface area effective for metal dispersion. It is preferred that the carbonaceous material have structure effective for gas diffusion.

One of skill in the art could readily choose a carbonaceous material for a particular application. Various carbonaceous materials are commercially available.

The carbonaceous catalyst used in the present invention further comprises one or more metals. Metal is defined above. In specific aspects, the metal can be, for example, platinum, iridium, osmium, rhenium, ruthenium, rhodium, palladium, vanadium, chromium, or a mixture thereof, or an alloy thereof. In one aspect, the metal is platinum. As defined above, the metal can also be alloys or oxides of metals effective as catalysts.

It is desired that the form and/or size of the metal provide the highest surface area of the metal possible per unit mass. It is desired that the size of the metal particles be kept as small as possible to achieve this end. Generally, in the art, average metal particle diameters end up as approximately 2 to about 6 nm during use in fuel cells due to sintering. A diameter less than about 2 nm can provide better performance.

The amount of metal can be any amount. The amount of metal can be an effective catalytic amount. One of skill in the art can determine an amount effective for the desired performance.

The metal can be about 2% to about 80% of the total carbonaceous composition, for example, about 3, 5, 7, 8, 10, 12, 13, 15, 17, 20, 22, 25, 27, 30, 32, 35, 37, 40, 42, 45, 47, 50, 52, 55, 57, 60, 62, 65, 67, 70, 72, 75, or 78%. The metal can be about 2% to about 60% of the composition, for example, about 5, 7, 10, 12, 15, 20, 25, 30, 35, 40, 45, 50, 55, or 57%. The metal can be about 20% to about 40% of the composition for example, about 22; 25, 30, 35, or 38%. The metal can be uniformly distributed on the composition, e.g., on the surface of the composition.

One of skill in the art could readily choose a metal to use in the composition for a particular application. Various metals are commercially available.

The metal can be uniformly distributed or dispersed on and/or in the carbonaceous substrate.

In one aspect, the metal particles are in nanocrystalline form. In another aspect, the metal particles, which are dispersed on a carbonaceous substrate, have a narrow particle size distribution.

In one aspect, the particulate carbonaceous material comprises a noble metal loaded carbon supported catalyst. In another aspect, the particulate carbonaceous material comprises a platinum-loaded carbon supported catalyst. In yet another aspect, the particulate carbonaceous material comprises a platinum loaded carbon black supported catalyst. In one aspect, examples of metal loaded catalysts can be found in for example, WO 03/100889 A1, WO 03/100883 A2, and WO 03/100884 A2, which are herein incorporated by this reference in their entireties and for such specific teachings.

The particulate material is in an aqueous slurry. In various aspects, the slurry comprises from 0.1 weight percent to 50 weight percent, from 0.1 to 10 weight percent, from 0.5 to 5 weight percent, from 1.5 to 1.9 weight percent, or 1.7 weight percent of the solid particulate material in the total aqueous slurry weight. The aqueous slurry can include other components besides the particulate material and water, such as, for example, optional surfactants, dispersants or wetting agents.

The anode and the cathode can be made of any suitable material typically used for an anode and cathode. The anode and cathode are typically electrochemically inert, and, as such, are typically platinum or gold. In one aspect, the anode and the cathode are platinum mesh or gauze.

A power source is provided between the anode and cathode to provide the electrical current, which is typically DC. The voltage produced by such a power source can be any amount sufficient to provide removal of the ions from the particulate material. As the voltage is increased, typically the time for removal of the ion contaminant from the particulate material is reduced. Use of a higher voltage can result in detrimental results, however, such as partial oxidization of the water, sintering of the particulate material, and excessive heat generation. In one aspect, in a process not utilizing the resin mixture material, the voltage is 120-140 V, and in another aspect, 128 V. In another aspect, by using the resin mixture material, the voltage is 25-45 V, and in another aspect, is 35 V. The voltage can be lower but the run time will be longer.

The ion exchange membrane materials can be any ion exchange membrane known to those of skill in the art. It is typically a planar and water permeable membrane. In one aspect, the ion exchange membrane materials are Excellion 1×1-100 cation exchange membrane and Excellion 1×1-200 anion exchange membrane, both available from Electopure, Inc., Lugana Hills, Calif., USA. The cation exchange membrane can be a Nafion® membrane.

The anion and cation exchange resin mixture is an optional layer of the present invention. Its use reduces the resistance of the system by providing an enhanced pathway for the current. The anion and cation exchange resin mixture layer is typically a homogeneous mixture of anion exchange resin and a cation exchange resin. The mixture can either be pre-mixed from the supplier, or the anion exchange resin can be purchased separately from the cation resin and mixed together in-house prior to use. Typically, the ratio of anion resin to cation resin is about 1:1, although this ratio can vary.

The anion and cation exchange resin mixture layer can be any ion exchange resin materials that are known to those of skill in the art. Typically, the resin is in bead form or can be made from cut up ion exchange membrane material. In a specific aspect, the anion and cation exchange resin mixture is Dowex MR-3 Mixed Bed Ion Exchange Resin (mixed anion and cation resin). In another aspect, the anion portion of the mixed resin is Dowex Monosphere 550A Anion Exchange Resin and the cation portion is Dowex 50WX-8 Cation Exchange Resin. Each of the Dowex products are available from Sigtna-Aldrich, Milwaukee, Wis., USA. The resin layer should be continuous to provide a current pathway.

In a separate aspect, small pieces of an ion exchange membrane can be mixed in with the anion and cation exchange resin mixture to enhance the electrical pathway. In this aspect, the membrane pieces are considered part of the definition of the resin mixture. For example, small pieces of Nafion® membrane, manufactured by DuPont, Wilmington, Del., USA, available from Sigma-Aldrich, Milwaukee, Wis., USA, can be added to the anion and cation exchange resin mixture. Additionally, small pieces of the anion exchange membrane or cation exchange membrane listed above can also be mixed with the anion and cation resin mixture.

The filter membrane is any porous membrane that allows for the transfer of ions through the membrane but keeps the particulate material from mixing with the anion and cation exchange resin layer. The filter membrane also keeps the resin material intact as a unitary layer. In various aspects, the filter membrane can be made of a porous polymer membrane, such as a polymer membrane of nylon or polypropylene. Examples of the filter membrane, include but are not limited to, Whatman Paper/Cellulose Filter Papers, for example, Whatman #2, available from Whatman, Inc., Clifton, N.J., USA, or Versapor 3000 Membrane Filters, available from Pall Corporation, Ann Arbor, Mich., USA.

In one aspect of the invention, a dielectric divider or wall is used, at least in part, between the anode chamber and the cathode chamber to prevent shorting out of the cell. In one aspect, such a dielectric member comprises a glass or polypropylene material.

In the process of this invention, there is a removal of at least one type of ion from the ion-containing particulate material. The ion type removed can be an anion, cation, or a mixture of both types. Typically, if an anion is removed, a comparable charge amount of cation will be removed and visa versa. The “at least some of” ions being removed intends in this invention to be some or essentially all of the ion of one or more type is effectively removed from the particulate material. The ion is typically removed to a low level, but does not have to be completely removed from the system in order for the process to be effective. That is, the goal is to minimize the amount of ion remaining on the particulate material or reduce the amount of ion to an acceptably low level, but it is not required that all of the ions be removed. The removal rate of the ions typically decreases as the amount of ions remaining decreases.

In one aspect, examples of ions that can be removed are chloride, nitrate, sulfate, chromium, copper, lead, nickel, calcium, iron, magnesium, cobalt, and sodium. Chloride ions are particularly important to remove as they hinder the catalytic activity of a catalyst in a fuel cell. Starting levels of chloride ions in fuel cell catalysts can be particularly high due to the use of chloroplatinic acid, which is a material used in the production of some platinum loaded catalysts.

In various aspects, the starting chloride ion concentration on the particulate material is greater than 5,000 ppm, greater than 2,000 ppm, or greater than 500 ppm. In one aspect, the current is passed for a sufficient time such that the ending chloride ion concentration on the particulate material is less than 100 ppm, in another aspect less than 60 ppm, in another aspect less than 40 ppm, and in another aspect less than 30 ppm.

The anion contaminant is removed from the particulate material and migrates toward the anode, and commensurately, the cation contaminant is removed from the particulate material and migrates toward the cathode of the cell.

The temperature of the system is typically from about 30 to about 60° C., from about 40 to about 50° C., or about 45° C., although a higher temperature can be used to speed up the process. However, higher temperatures can create sintering problems, especially when metal loaded catalysts are purified.

The process of this invention can be a batch process, continuous process, or a semi-continuous process. In a continuous process, typically the particulate aqueous slurry is continuously fed through a center chamber. The anions pass through an anion exchange membrane into a chamber containing an aqueous medium and the anions subsequently continue to migrate in a further path towards the anode. Commensurately, the cations pass from the center chamber through a cation exchange membrane into a chamber containing typically an aqueous medium and then migrate towards the cathode. The chambers containing the aqueous medium between the anode and anion exchange membrane and between the cathode and the cation exchange membrane can be operated in a continuous manner to carry away the anions and cations out of the process. Alternatively, these chambers can be operated in a semi-continuous manner to periodically flush water or some other solvent through such chambers to periodically remove the buildup of the anion and cation on the anode and cathode, respectively.

The EDI process of the present invention can be used alone, or in another aspect, the particulate material can be pretreated with either a hot water wash, a soxhlet extraction, or both.

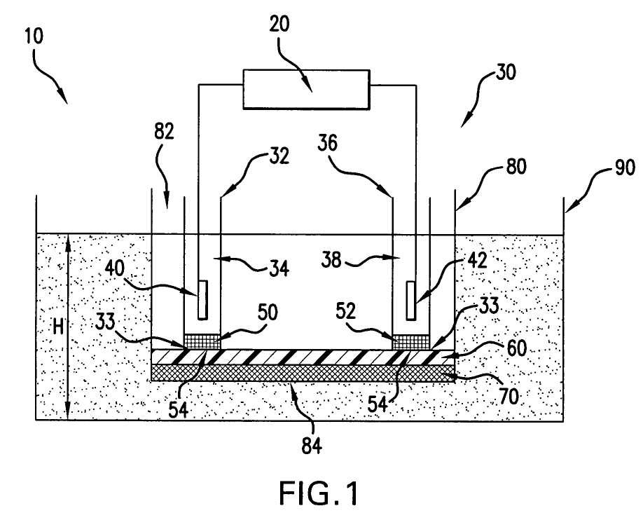

An exemplary schematic illustration of the electrodeionization device 10 of the present invention is shown in FIG. 1. The electrodeionization device includes the power source 20 and a cell 30. The cell includes a first chamber 32 that defines a first interior cavity 34 and a second chamber 36 that defines a second interior cavity 38. The cell further includes an anode 40 and a cathode 42, which are both electrically coupled to the power source 20. The anode 40 is contained at least partially within the first interior cavity 34 of the first chamber and the cathode 42 is contained at least partially within the second interior cavity 38 of the second chamber. The path length between anode 40 and cathode 42 can be minimized for optimum performance. In one aspect of the invention, the respective first and second chambers of the cell are integrally formed together such that a portion of the first chamber and a portion the second chamber form a common wall 35 (not shown). In a further aspect of the invention, at least a portion of the common wall is formed from a dielectric member 37 (not shown) to prevent shorting out and corrosion of the device. Such a dielectric member, in one aspect, is made of glass or polypropylene.

The cell 30 also includes an anion exchange membrane 50 and a cation exchange membrane 52. The anion exchange membrane is positioned adjacent a bottom end 33 of the first chamber 32 in communication with the first interior cavity 34 and the cation exchange membrane 52 is positioned adjacent a bottom end 33 of the second chamber 36 in communication with the second interior cavity 38. Both the anion exchange membrane 50 and the cation exchange membrane 52 have a base surface 54.

The cell can also have an anion and cation exchange resin mixture layer 60 that is positioned adjacent to the respective base surfaces 54 of the anion and cation exchange membranes 50, 52. In one aspect, the respective anion and cation exchange membranes 50, 52 are disposed between the anode 40 and the cathode 42, respectively, and the resin mixture layer 60.

The cell 30 of the device 10 can also include a filter membrane 70. In one aspect, the resin mixture layer 60 is disposed between the respective anion and the cation exchange membranes 50, 52 and the filter membrane 70.

The device can also include a housing 80 and a vessel 90. The housing 80 defines an interior volume 82 and further defines at least one opening 84 in communication with the interior volume of the housing. In use, the cell 30 is positioned at least partially therein the interior volume 82 of the housing. The vessel 90 is conventionally shaped for holding an aqueous slurry of the particulate material. The housing 80 can be at least partially contained within the vessel such that the at least one opening 84 of the housing is in fluid communication with the aqueous slurry.

In various aspects, the anion and cation exchange resin mixture layer can be proximate to, adjacent to, or adjacent to and in contact with the anion exchange membrane and/or cation exchange membrane. In various aspects, the filter membrane can be proximate to, adjacent to, or adjacent to and in contact with the anion and cation exchange resin mixture layer.

In use, the vessel 90 is filled with the aqueous slurry of the particulate material up to a sufficient height, H, and the housing containing the cell 30 is partially submerged within the vessel to provide electrical contact to complete a direct current circuit. The power source 20 is turned on and is maintained for a sufficient time for the sufficient removal of at least some of the at least one type ion to be removed from the particulate material. Upon completion of the ion removal, the power source is turned off, and the housing and cell are removed from the vessel. The purified particulate material is then recovered from the interior of the vessel.

In the method of this invention, anion impurities on the particulate material tend to migrate from the aqueous slurry towards the anode. The anions within the aqueous slurry are in electrical contact with the anion and cation exchange resin mixture layer, the anion exchange membrane, and the anode. Likewise, the cation impurities on the particulate material tend to migrate to the cathode by being in electrical contact with the anion and cation exchange resin mixture layer, the cation exchange membrane, and the cathode.

The temperature of the aqueous slurry of the particulate material can be controlled as desired using standard temperature control techniques known in the art (not shown). Additionally, in one aspect, the aqueous slurry of the particulate material can be stirred continuously and/or discontinuously to homogenously mix the particulate material using standard techniques known in the art (not shown). The housing or cell can free float within vessel, or can be attached to vessel.

In one specific aspect, the first chamber 32 and second chamber 36 are glass tubes from Ace Glass (Vineland, N.J.) that are 28 mm O.D. and 100 mm long, with Ace Threads (#32GL) on one end. In one specific aspect, multiple tubes 32 and multiple tubes 36 are used. An Ace plastic threaded cap with a hole is attached to the threaded end of the tube. The membrane material 70 is affixed between the top of the threaded end of the tube and the cap. The caps and threaded tubes are optional. Alternatively, larger tubes can be used, such as a 40 mm O.D. by 100 mm long threaded tube, using Ace threads (45GL).

When the small glass tubes are used, they are spaced approximately 2 cm apart (space between tubes), with a center to center distance of approximately 4.5 cm. This distance is that required by the body of the threaded cap used. If smaller caps or no caps are utilized, the tubes can be positioned immediately adjacent to and in contact with each other. As the distance between the tubes (pathlength) increases, efficiency (current output) typically decreases. Using larger tubes and thus, increasing the surface area of the membranes, typically provides a linear increase in the current output.

The glass tubes are immersed in a plastic ring, jar, or bucket large enough to hold the desired number of tubes and resin into which a filter membrane can be placed and exchange resin subsequently added thereto. The entire assembly is then immersed or lowered into a larger vessel containing the slurry of ion containing material.

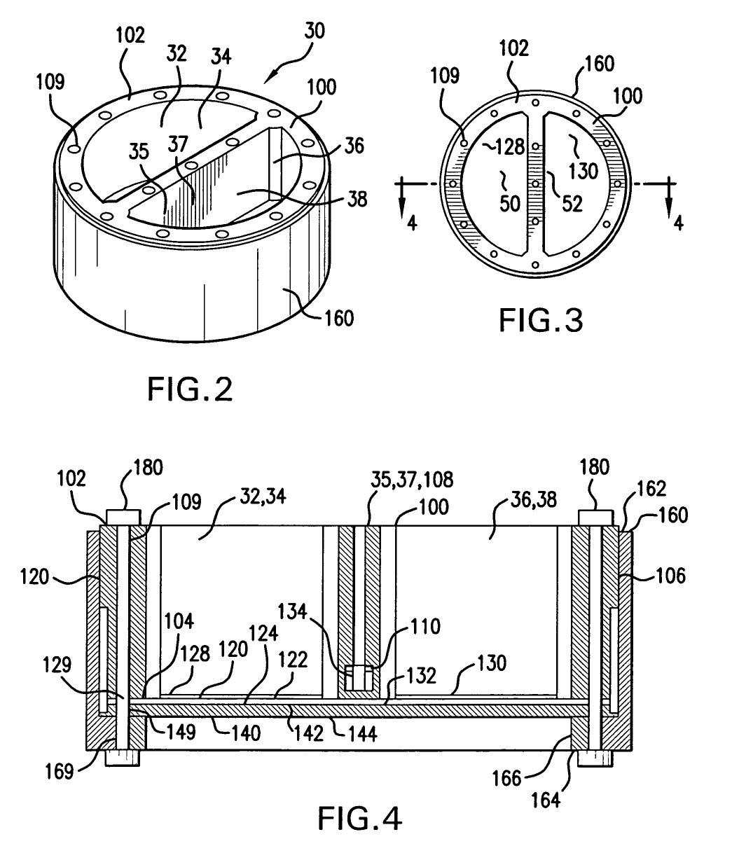

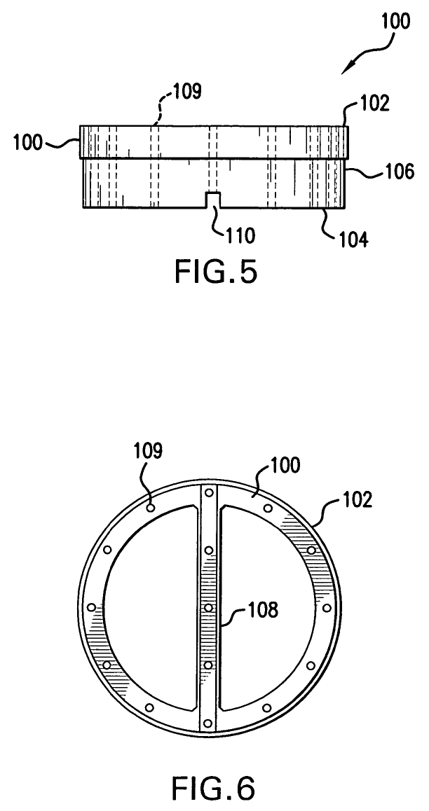

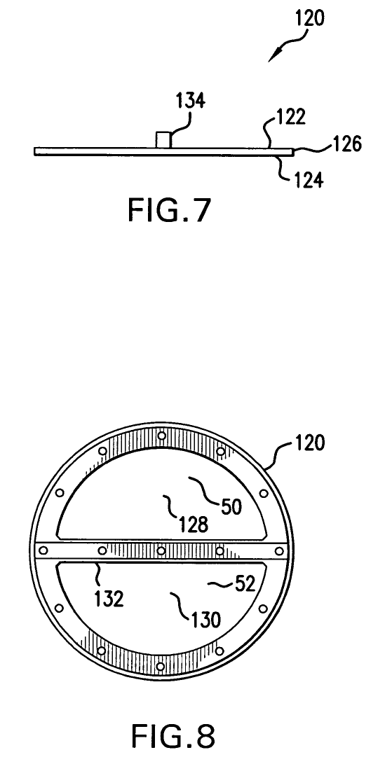

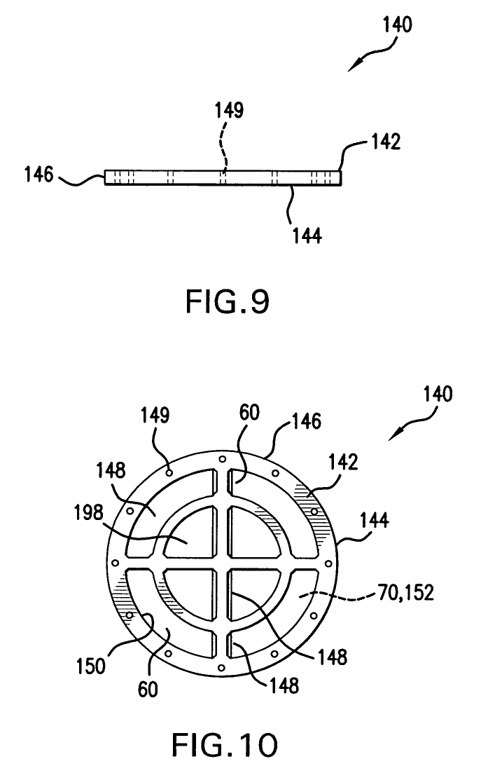

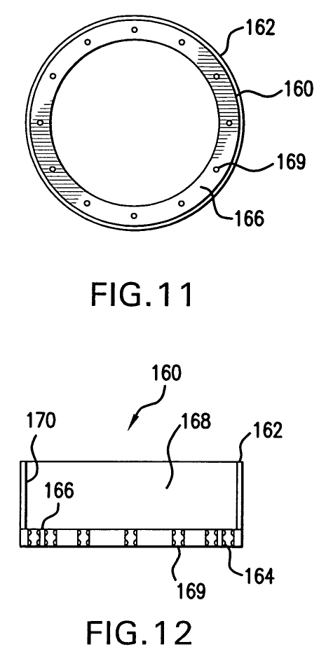

Referring now to FIGS. 2-14, in one aspect, the cell 30 of the electrodeionization device can include a cell body 100, an upper frame member 120, a lower frame member 140, and a sleeve 160. The cell body 100 has a top end 102, a spaced bottom end 104, and an exterior peripheral surface 106. As one will appreciate, the cell body 100 defines the respective first and second chambers 34, 36 of the cell. In one aspect, the respective first and second chambers extend substantially between the top end and bottom end of the cell body. In another aspect, a portion of the first chamber 34 and a portion of a second chamber 36 form a common cell body wall 108. Portions of the common cell body wall 108 can form a portion of the respective top and bottom ends of the cell body. In an alternative embodiment, at least a portion of the common cell body wall 108 is formed from the dielectric member 37. In one aspect of the invention, the first interior cavity 34 and the second interior cavity 38 have substantially the same volume.

The upper frame member 120 has an upper surface 122, an opposed lower surface 124, and an upper frame peripheral edge surface 126. In one aspect, the upper frame member 120 defines a first opening 128 and a second opening 130 that extends between the upper and lower surfaces of the upper frame member. The defined first and second openings 128, 130 form a common wall member 132 that extends between a portion of the first opening and a portion of the second opening. The upper frame member 120 is sized and shaped for underlying registration with the cell body 100 such that, in use, at least a portion of the upper surface 122 of the upper frame member underlies at least a portion of the bottom end 104 of the cell body. In another aspect of the invention, the anion exchange membrane 50 is mounted in the first opening 128 of the upper frame member and the cation exchange membrane 52 is mounted in the second opening 130 of the upper frame member.

In use, the first opening 128 underlies and is in substantial registration with the first interior cavity 34 of the first chamber, the second opening 130 underlies and is substantial registration with the second interior cavity 38 of the second chamber, and the common wall member 132 underlies and is substantial registration with the common cell body wall 108. In one aspect, the common wall member 132 defines a male protrusion 134 that extends generally transverse to the upper surface of the upper frame member and the common cell body wall 108 defines a female indentation 110 that extends generally transverse to the bottom surface of the cell body. In this aspect, the male protrusion 134 and female indentation 110 are sized and shaped for complementary keyed connection.

The lower frame member 140 of the cell has a top face 142, an opposed bottom face 144, and a lower frame peripheral edge surface 146. At least one opening 148, extending between the top and bottom faces, is defined in the lower frame member. The lower frame member 140 is sized and shaped for underlying registration with the upper frame member such that, in use, at least a portion of the top face 142 of the lower frame member underlies at least a portion of the lower surface 124 of the upper frame member. In one aspect, the at least one opening is a plurality of openings. In one embodiment, the anion and cation exchange resin mixture layer 60 can be mounted within an upper portion 150 of the at least one opening 148 proximate the top face 142 of the lower frame member. In this embodiment, the filter membrane 70 can be mounted within a lower portion 152 of the at least one opening 148 proximate the bottom face 144 of the lower frame member. In this example, the anion and cation exchange resin mixture layer 60 and the filter membrane 70 form a layered structure. In an alternative embodiment, the anion and cation exchange resin mixture layer 60 can be mounted within at least a portion of the at least one opening 148 of the lower frame member.

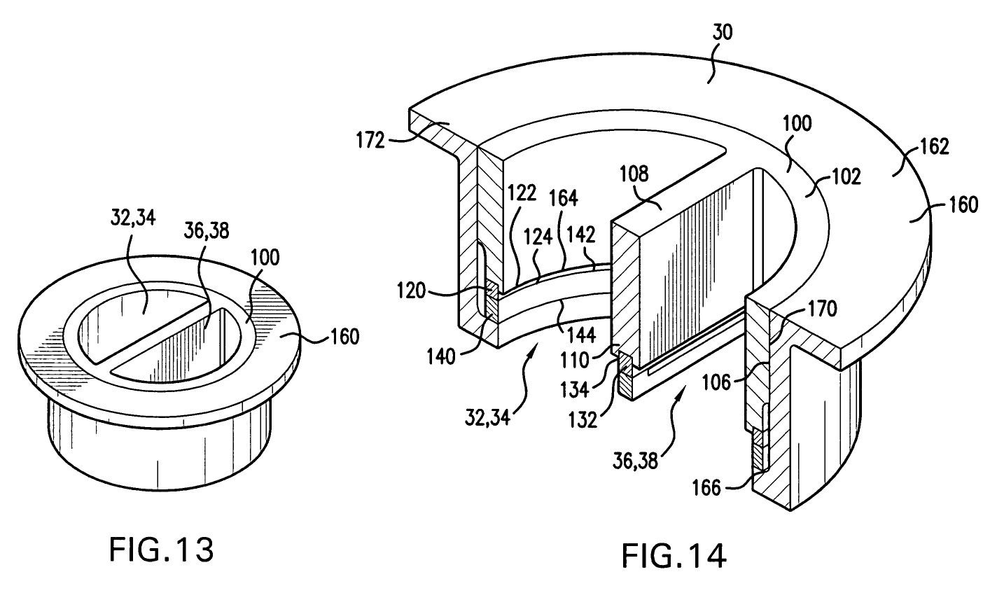

The sleeve 160 of the cell 30 has an open distal end 162 and an opposed open proximal end 164. The proximal end 164 of the sleeve has an inwardly extending flange 166 formed therein. The sleeve 160 defines a bore 168 that extends from the distal end of the sleeve to the flange. In one aspect, the bore 168 of the sleeve has an interior surface 170 that is sized and shaped for complementary fit with at least one of the exterior peripheral surface 106 of the cell body and the respective peripheral edge surfaces 126, 146 of the upper and lower frame members 120, 140. In one example, in use, at least a portion of the bottom face 144 of the lower frame member overlies at least a portion of the flange 166. In an alternate embodiment shown partially in FIGS. 13 and 14, the distal end 162 of the sleeve has a flange that extends substantially traverse to the distal end so that the sleeve of the cell can be supported by the edges of the vessel.

In use, the cell body and the respective upper and lower frame members are stacked relative to each other within the sleeve. In one aspect, the cell body and the respective upper and lower frame members are selectively releaseable positioned relative to each other and the sleeve. In one example, the cell body and the respective upper and lower frame members are friction fit within the sleeve of the cell so that they are fixed relative to each other. In another example, at least a portion of the exterior peripheral surface of the cell body and at least a portion of the interior surface of the sleeve have a complementary threaded surface. It will be appreciated that the upper and/or lower frame members can have any desired geometric shape such as, for example, a generally circular ring shape, a generally square shape, a generally rectangular shape, and the like.

In an alternative example, the cell body 100 defines at least one cell body bore 109 that extends from the top end to the bottom end of the cell body, the upper frame member 120 defines at least one upper frame member bore 129 that extends from the upper surface to the lower surface of the upper frame member, the lower frame member 140 defines at least one lower frame member bore 149 that extends from the top face to the bottom face of the lower frame member, and the flange 166 of the sleeve defines at least one flange bore 169. In use, the at least one cell body bore, the at least one upper frame member bore, the at least one lower frame member bore, and the flange bore are positioned substantially co-axial to each other. In this example, a conventional fastener 180, such as, for example, a nut, a nut and bolt, a screw, a friction-fit rod, and the like, sized and shaped for complementary fit within the substantially co-axial at least one cell body bore 109, at least one upper frame member bore 129, at least one lower frame member bore 149, and flange bore 169 can be provided such that the cell body, the upper frame member, the lower frame member, and the sleeve can be releasable secured relative to each other.

Gaskets can be provided for aiding in maintaining the fluid integrity of the cell when it is connected together. For example, a first gasket can be disposed between a portion of the upper surface of the upper frame member and a portion of the bottom end of the cell body. Similarly, a second gasket can be disposed between a portion of the lower surface of the upper frame member and a portion of the top face of the lower frame member. Additionally, a third gasket can be disposed between a portion of the bottom face of the lower frame member and a portion of the flange.

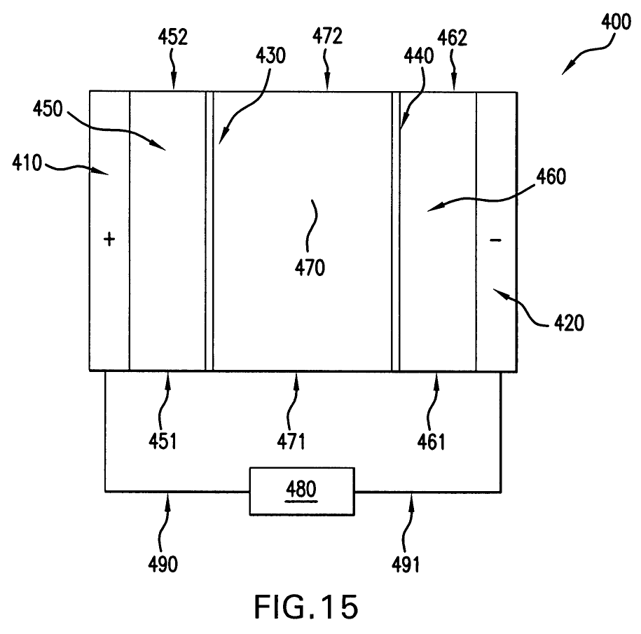

A continuous or semi-continuous device is shown in FIG. 15. The cell 400 includes an anode 410, cathode 420, and a center chamber 470 formed from the anion exchange membrane 430 and cation exchange membrane 440. Between anode 410 and the anion exchange membrane 430 is the anion exchange chamber 450 and between the cathode 420 and the cation exchange membrane 440 is the cation exchange chamber 460. Anode 410 is connected to cathode 420 via hard wires 490 and 491 and power source 480. The aqueous slurry of the particulate material enters the center chamber at 472 and exits the center chamber at 471. Water or other solvent flows through the anode chamber 450 to remove the anions, flowing either from 452 to 451 or vice versa. Likewise, water or other solvent flows through cathode chamber 460 to remove cations and flows either from 462 to 461 or vice versa. The flow of the water or other solvent through the chambers 450 and 460 can be in a continuous manner or semi-continuous manner. In a semi-continuous manner, the water or solvent flows through the respective chamber in a periodic manner to remove the ions on an as needed basis. Typically, the anion and cation exchange resin material is not utilized in the continuous device 400.

In another aspect, in any of the devices or processes of the present invention, the anode and cathode can be provided as multiple anodes and cathodes arranged in an alternating pattern or array. Specifically, in one aspect, a column of anodes is provided adjacent to a column of cathodes, which are adjacent to a column of anodes, which are adjacent to a column of cathodes, etc. This alternating pattern of columns of anodes and cathodes can be repeated as appropriate. This array approach minimizes the path length between the anodes and cathodes. In this aspect, any number of anodes and cathodes can be provided.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1 (Comparative)

Two samples of 40% platinum on CDX-975 carbon black catalyst (manufactured and sold by Columbian Chemicals Company, Marietta, Ga., USA) were washed using a pressure filtration unit and Versapor 3000 membrane filters (Pall Corp.). The samples were washed six times, each wash using 1 liter of distilled water. Distilled water used for the first three washes was at ambient temperature. Distilled water used for the final three washes was at approximately 70° C. The starting chloride ion concentration was believed to be about 2,000 to 5,000 ppm, and the final chloride ion concentration on the two carbon catalyst samples were 128 and 202 ppm.

### Example 2 (Comparative)

Three samples of 60% platinum on Ketjen EC-600 catalyst (manufactured by Ketjen Black International Company, sold through Akzo Nobel Polymer Chemicals, Chicago, Ill., USA) were initially washed as described above in Example 1 (hot water wash). The samples were subsequently placed in the extraction thimble of a Soxhlet extraction apparatus charged with distilled water. The soxhlets were heated to boiling for 8 hours. The starting chloride ion concentration was believed to be about 2,000 to 5,000 ppm, and the final chloride ion concentration on three carbon catalyst samples were 76 ppm, 95 ppm, and 108 ppm.

### Example 3

An electrodeionization (EDI) device for removal of ions from carbon supported catalysts was used as illustrated generally in FIG. 1. The anode and cathode electrodes were both made of a piece of platinum foil. The anion exchange membrane used was Excellion IX 1-200 Anion Exchange Membrane and the cathode exchange membrane used was Excellion IX 1-100 Cation Exchange Membrane, both Excellion exchange membranes available from Electopure, Inc., Lugana Hills, Calif., USA. The exposed areas of the ion exchange membrane were about 1 cm². Both the anode and cathode chambers were filled with water to about ⅔ of their 10 cm-heights. A layer of a mixture of anion and cathode exchange resins was used, specifically, Dowex MR-3 Mixed Bed Ion Exchange Resin, Sigma-Aldrich, Milwaukee, Wis., USA, wherein the anion exchange resin and cation exchange resin were used in approximately a 1:1 ratio. Small pieces of the Excellion cation and anion exchange membranes were cut into about 1-2 cm² pieces and mixed with the anion exchange resin mixture. The ion exchange resin mixture rested on a Versapor 3000 filter membrane.

10 grams of a catalyst sample of 40% platinum on CDX-975 carbon black catalyst were water washed according to the procedures of Example 1. The catalyst sample was then put into a beaker and about 600 ml of water was added with stirring to form a slurry. The temperature of the slurry was controlled at about 45° C. The EDI device was put on top of the beaker and about ⅔ of the device was immersed below the water level. A power supply was connected to the EDI device, with the positive power supply connected to the anode electrode and the negative power supply connected to the cathode. A voltage of about 35 V DC was applied for about 20 hours. After that, the EDI device was removed and the catalyst was filtered. The impurity results are shown in Table 1 below. The starting chloride ion concentration for the specific catalyst used in each of the Examples 3-8 was not measured. However, for Examples 3-8, it is believed that the chloride ion concentration ranged from about 2,000 ppm to about 5,000 ppm prior to the hot water wash and from about 100 to about 200 ppm chloride ion after the hot water wash and prior the EDI treatment.

TABLE 1

| Impurity Name | Amount (ppm) |
|---|---|
| Chloride | 15 |
| Sulfate | 276 |
| Chromium | 3.6 |
| Copper | 4.9 |
| Lead | 4.5 |
| Nickel | 19 |
| Calcium | 94 |
| Iron | 60 |
| Magnesium | 2.9 |
| Cobalt | 1.8 |

### Example 4

The same process and device of Example 3 were repeated with 15 grams of a 55% platinum on Ketjen EC₃₋₀₀ carbon catalyst (manufactured by Ketjenblack International Company, sold through Akzo Nobel Polymer Chemicals, Chicago, Ill., USA), previously water washed according to Example 1 and additionally washed with 0.1 M H₂SO₄. After about 17 hours, 17 minutes the temperature was adjusted to about 55° C. until the end of the run at 19 hours, 8 minutes. The final chloride ion impurity level on the carbon catalyst was 22 ppm.

### Example 5

The same process and device of Example 3 was utilized except that 9.7 grams of 55% platinum Ketjen EC₃₋₀₀ carbon catalyst previously water washed according to Example 1 and additionally washed with 0.1 M H₂SO₄ was utilized. 500 ml of water was used. The temperature ranged from about 32° C. to 63° C. The applied voltage was 40 V DC. The total run time was 12 hours, 16 minutes. The final chloride ion concentration of the catalyst material was 25 ppm.

### Example 6

The same process and device as Example 3 was utilized except that the sample (unknown quantity) of 50% platinum on CDX-975 carbon catalysts, previously water washed according to Example 1 and additionally washed with 0.1 M H₂SO₄, was used. The temperature was controlled to about 45° C. for a total run time of 17 hours, 15 minutes. The final chloride ion concentration on the carbon catalysts was 37 ppm.

### Example 7

The same process and device as Example 3 was utilized except that 22 grams of 50% platinum on Ketjen EC-300 carbon catalyst, previously water washed according to Example 1 (with no acid wash), was used. The temperature was originally set to about 45° C. and at about 16 hours, 12 minutes was adjusted to about 55° C. The total run time was 19 hours, 5 minutes. The final chloride ion concentration on the carbon catalyst was 36 ppm.

### Example 8

The same process and device as Example 3 was utilized except that no ion exchange resin layer was utilized. Additionally, 10.9 grams of 50% platinum on Ketjen EC-300 carbon catalysts, previously water washed according to Example 1 and additionally washed with 1 M H₂SO₄, was used. 128 V DC current was applied. The temperature was not recorded. The total run time was 4 hours, 20 minutes. The final chloride ion concentration on the carbon catalyst was 23 ppm.

Throughout this application, various publications are referenced. The disclosures of these publications in their entireties are hereby incorporated by reference into this application in order to more fully describe the compounds, compositions, devices, articles, and/or methods described herein.

Various modifications and variations can be made to the inventions described herein. Other aspects of the inventions described herein will be apparent from consideration of the specification and practice of the inventions disclosed herein. It is intended that the specification and examples be considered as exemplary.

What is claimed is:

1. A method for the electrodeionization and removal of at least some of at least one type of ion from an ion-containing particulate carbonaceous material comprising passing a direct current for a sufficient time between (a) an anode and (b) a cathode,
wherein the anode and the cathode are both in electrical contact with an aqueous slurry of the particulate carbonaceous material,
wherein the anode is in electrical contact with an anion exchange membrane and
wherein the cathode is in electrical contact with a cation exchange membrane,
thereby causing the removal of at least some of the at least one type of ion to be removed from the carbonaceous material.

2. The method of claim 1, wherein the anode and the cathode are both in electrical contact with an anion and cation exchange resin mixture layer, wherein the anion exchange membrane is disposed between the anode and the resin mixture layer and the cathode exchange membrane is disposed between the cathode and the resin mixture layer.

3. The method of claim 2, further comprising a filter membrane, wherein the resin mixture layer is disposed between (i) the anion and the cation exchange membranes and (ii) the filter membrane.

4. The method of claim 1, wherein the particulate carbonaceous material comprises a carbon supported catalyst.

5. The method of claim 1, wherein the particulate carbonaceous material comprises a noble metal loaded carbon supported catalyst.

6. The method of claim 1, wherein the particulate carbonaceous material comprises a platinum loaded carbon supported catalyst.

7. The method of claim 1, wherein the particulate carbonaceous material comprises a platinum loaded carbon black supported catalyst.

8. The method of claim 1, wherein the anode and cathode comprise platinum.

9. The method of claim 1, wherein the method is a batch process.

10. The method of claim 1, wherein the method is a continuous process.

11. The method of claim 1, wherein the at least one type of ion comprises a chloride ion.

12. The method of claim 11, wherein the starting chloride ion concentration on the particulate carbonaceous material is greater than 500 ppm and the current is passed for a sufficient time such that the ending chloride ion concentration on the particulate carbonaceous material is less than 100 ppm.

13. The method of claim 12, wherein the ending chloride ion concentration is less than 40 ppm.

14. A method for the electrodeionization and removal of at least some of at least one type of ion from an ion-containing particulate material comprising passing a direct current for a sufficient time between (a) an anode and (b) a cathode,
wherein the anode and the cathode are both in electrical contact with an aqueous slurry of the particulate material,
wherein the anode is in electrical contact with an anion exchange membrane and
wherein the cathode is in electrical contact with a cation exchange membrane,
thereby causing the removal of at least some of the at least one type of ion to be removed from the particulate material.

15. A device for the electrodeionization and removal of at least some of at least one type of ion from an ion-containing particulate material comprising:
a power source; and
a cell comprising:
(a) a first chamber defining a first interior cavity;
(b) a second chamber defining a second interior cavity;
(c) an anode contained at least partially in the first interior cavity, the anode electrically coupled to the power source;
(d) a cathode contained at least partially in the second interior cavity, the cathode electrically coupled to the power source;
(e) an anion exchange membrane positioned adjacent a bottom end of the first chamber, the anion exchange membrane having a base surface;
(f) a cation exchange membrane positioned adjacent a bottom end of the second chamber, the cation exchange membrane having a base surface; and
(g) an anion and cation exchange resin mixture layer positioned adjacent to the respective base surfaces of the anion and cation exchange membranes,
wherein the respective anion and cation exchange membranes are disposed between the anode and the cathode, respectively, and the resin mixture layer.

16. The device of claim 15, wherein the cell further comprises a filter membrane, wherein the resin mixture layer is disposed between the respective anion and the cation exchange membranes and the filter membrane.

17. The device of claim 16, further comprising a housing defining an interior volume and further defining at least one opening in communication with the interior volume of the housing, wherein the cell is positioned at least partially therein the interior volume of the housing.

18. The device of claim 17, further comprising a vessel for holding an aqueous slurry of the particulate material, wherein the housing is contained within the vessel such that the at least one opening of the housing is in fluid communication with the aqueous slurry.

19. The device of claim 15, wherein the resin mixture further comprises pieces of an ion exchange membrane.

20. The device of claim 15, wherein the respective first and second chambers are integrally formed together such that a portion of the first chamber and a portion the second chamber form a common wall.

21. The device of claim 20, wherein at least a portion of the common wall is formed from a dielectric member.

22. The device of claim 16, wherein the cell further comprises a cell body having a top end, a spaced bottom end, and an exterior peripheral surface, the cell body defining the respective first and second chambers of the cell, wherein the respective first and second chambers extend substantially between the top end and bottom end of the cell body.

23. The device of claim 22, wherein a portion of the first chamber and a portion of a second chamber form a common cell body wall, and wherein portions of the common cell body wall forms a portion of the respective top and bottom ends of the cell body.

24. The device of claim 23, wherein at least a portion of the common cell body wall is formed from a dielectric member.

25. The device of claim 23, wherein the first interior cavity and the second interior cavity have substantially the same volume.

26. The device of claim 23, wherein the cell further comprises an upper frame member having an upper surface, an opposed lower surface, and an upper frame peripheral edge surface, the upper frame member defining a first opening and a second opening extending between the upper and lower surfaces and forming a common wall member extending between a portion of the first opening and a portion of the second opening, wherein the upper frame member is sized and shaped for underlying registration with the cell body such that, in use, at least a portion of the upper surface of the upper frame member underlies at least a portion of the bottom end of the cell body.

27. The device of claim 26, wherein, in use, the first opening underlies and is in substantial registration with the first interior cavity, the second opening underlies and is substantial registration with the second interior cavity, and the common wall member underlies and is substantial registration with the common cell body wall.

28. The device of claim 27, further comprising a first gasket disposed between a portion of the upper surface of the upper frame member and a portion of the bottom end of the cell body.

29. The device of claim 26, wherein the anion exchange membrane is mounted in the first opening of the upper frame member, and wherein the cation exchange membrane is mounted in the second opening of the upper frame member.

30. The device of claim 26, wherein the common wall member defines a male protrusion extending generally transverse to the upper surface of the upper frame member, wherein the common cell body wall defines a female indentation extending generally transverse to the bottom end of the cell body, and wherein the male protrusion and female indentation are sized and shaped for complementary keyed connection.

31. The device of claim 26, wherein the cell further comprises a lower frame member having a top face, an opposed bottom face, and a lower frame peripheral edge surface, the lower frame member defining at least one opening extending between the top and bottom faces, and wherein the lower frame member is sized and shaped for underlying registration with the upper frame member such that, in use, at least a portion of the top face of the lower frame member underlies at least a portion of the lower surface of the upper frame member.

32. The device of claim 31, wherein the at least one opening is a plurality of openings.

33. The device of claim 31, wherein the anion and cation exchange resin mixture layer is mounted within an upper portion of the at least one opening proximate the top face of the lower frame member.

34. The device of claim 33, wherein the filter membrane is mounted within a lower portion of the at least one opening proximate the bottom face of the lower frame member.

35. The device of claim 31, further comprising a second gasket disposed between a portion of the lower surface of the upper frame member and a portion of the top face of the lower frame member.

36. The device of claim 31, wherein the cell further comprises a sleeve having an open distal end and an opposed open proximal end that has an inwardly extending flange, the sleeve defining a bore extending from the distal end of the sleeve to the flange.

37. The device of claim 36, wherein, in use, at least a portion of the bottom face of the lower frame member overlies at least a portion of the flange, and wherein the bore of the sleeve has an interior surface that is sized and shaped for complementary fit with the exterior peripheral surface of the cell body and the respective peripheral edge surfaces of the upper and lower frame members.

38. The device of claim 36, further comprising a third gasket disposed between a portion of the bottom face of the lower frame member and a portion of the flange.

39. The device of claim 36, wherein the cell body defines at least one cell body bore extending from the top end to the bottom end of the cell body, wherein the upper frame member defines at least one upper frame member bore extending from the upper surface to the lower surface of the upper frame member; wherein the lower frame member defines at least one lower frame member bore extending from the top face to the bottom face of the lower frame member, wherein the flange of the sleeve defines at least one flange bore, wherein, in use, the at least one cell body bore, the at least one upper frame member bore, the at least one lower frame member bore, and the flange bore are positioned substantially co-axial to each other, further comprising a fastener sized and shaped for complementary fit within the substantially co-axial at least one cell body bore, at least one upper frame member bore, at least one lower frame member bore, and flange bore such that the cell body, the upper frame member, the lower frame member, and the sleeve can be releasable secured relative to each other.

40. The device of claim 39, wherein the fastener is a bolt and a complementary nut.

41. The device of claim 39, wherein the fastener is a screw.

42. The device of claim 39, wherein the fastener is a friction-fit rod.

43. The device of claim 15, wherein at least two anodes and at least two cathodes are provided.

44. A frame member for a cell for the electrodeionization and removal of at least some of at least one type of ion from an ion-containing particulate material, comprising:
an anion exchange membrane;
a cation exchange membrane; and
a member having an upper surface and an opposed lower surface, the member defining a first opening and a second opening extending between the upper and lower surfaces and forming a common wall member extending between a portion of the first opening and a portion of the second opening, wherein the anion exchange membrane is mounted in the first opening of the member, and wherein the cation exchange membrane is mounted in the second opening of the member.

45. The frame member of claim 44, wherein the first opening and the second opening have substantially the same area.

46. A frame member for a cell for the electrodeionization and removal of at least some of at least one type of ion from an ion-containing particulate material, comprising:
an anion and cation exchange resin mixture layer;
a filter membrane; and
a substantially planar member having a top face and an opposed bottom face, the member defining at least one opening extending between the top face and the bottom face, wherein the anion and cation exchange resin mixture layer is mounted within an upper portion of the at least one opening proximate the top face of the member, and wherein the filter membrane is mounted within a lower portion of the at least one opening proximate the bottom face of the member.

47. The frame member of claim 46, wherein the at least one opening is a plurality of openings.
